(19) United States
(12) Patent Application Publication
(10) Pub. No.: US 2005/0026494 A1
(43) Pub. Date: Feb. 3, 2005

(54) Connector small in size and simple in structure

(75) Inventors: Takaaki Kudo, Tokyo (JP); Daisuke Machihara, Saitama (JP)

Correspondence Address: WILLIAM COLLARD;COLLARD & ROE, P.C., 1077 NORTHERN BOULEVARD, ROSLYN, NY, 11576, US

(73) Assignee: Japan Aviation Electronics Industry, Limited

(21) Appl. No.: 10/899,409

(22) Filed: Jul. 26, 2004

(30) Foreign Application Priority Data
Jul. 30, 2003 (JP) JP 2003-282370
Jul. 16, 2004 (JP) JP 2004-210475

(51) Int. Cl. H01R 13/58

(52) U.S. Cl. 439/495

(57) ABSTRACT

A connector is for connecting a connection object which has a wiring portion, a protruding portion protruding from the wiring portion on one side thereof, and a wiring pattern extending from the wiring portion to the protruding portion. In the connector, a housing has a main body portion provided with a receiving surface for receiving the wiring portion. The housing further has a side portion disposed at one side of the main body portion. The side portion has a receiving groove for receiving the protruding portion. A contact is held by the side portion so as to be connected to said wiring pattern of the protruding portion.

This application claims priority to prior Japanese application JP 2003-282370, the disclosure of which is incorporated herein by reference.

### BACKGROUND OF THE INVENTION

This invention relates to a connector for use in connection of a connection object, such as a flexible board.

For example, Japanese Patent Application Publication (JP-A) No. H7-153531 discloses a connector for connecting a flat cable as a connection object.

Referring to FIG. 1, the connector disclosed in the above-mentioned publication will be described. The connector depicted at 41 has a U-shaped housing. The housing 42 is provided with a pair of tail plates 43 formed at opposite sides of an end portion thereof. The housing 42 has a bottom portion 42c provided with a plurality of contact receiving grooves 42c1. In the contact receiving grooves 42c1, a plurality of contacts 46 are received and held, respectively. Each contact 46 has a front end provided with a contacting portion 46a to be contacted with a corresponding one of a plurality of contacting patterns 54 of a flat cable 51, and a rear end provided with an engaging portion 46b. The engaging portion 46b is inserted into a through hole 42a1 formed at a base portion 42a of the housing 42.

The connector 41 has a recessed portion 44 formed between the base portion 42a of the housing 42 and the tail plates 43 and defined by left and right side portions 42b and the bottom portion 42c of the housing 42.

The flat cable 51 has one end provided with a connection base portion 52 of a rectangular shape. The connection base portion 52 has a rear end connected to an extending portion 53 narrower in width than the connection base portion 52. The connection base portion 52 has an upper surface provided with the contacting patterns 54. The extending portion 53 has an upper surface provided with a plurality of wiring patterns 55. The contacting patterns 54 are connected to the wiring patterns 55, respectively. The connection base portion 52 has a lower surface to which a reinforcing plate 56 is fixedly attached.

The flat cable 51 and the connector 41 are connected to each other in the following manner. The flat cable 51 is turned upside down from a position illustrated in FIG. 1. The connection base portion 52 is inserted into the recessed portion 44 of the connector 41. Then, the contacting patterns 54 are contacted with the contacting portions 46a of the contacts 46.

In the above-mentioned connector 41, the housing 42 has the base portion 42a and the left and the right side portions 42b. Therefore, the connector 41 is complicated in structure and is inevitably increased in overall size.

### SUMMARY OF THE INVENTION

It is therefore an object of the present invention to provide a connector small in size and simple in structure.

Other objects of the present invention will become clear as the description proceeds.

According to an aspect of the present invention, there is provided a connector for connecting a connection object which has a wiring portion, a first protruding portion protruding from the wiring portion on one side thereof, and a wiring pattern extending from the wiring portion to the first protruding portion. The connector comprises a housing and a first contact held by the housing, the housing having a main body portion provided with a receiving surface for receiving the wiring portion and a first side portion disposed at one side of the main body portion, the first side portion having a first receiving groove for receiving the first protruding portion, the first contact being held by the first side portion so as to be connected to the wiring pattern of the first protruding portion.

### BRIEF DESCRIPTION OF THE DRAWING

FIG. 1 is a perspective view showing a conventional connector together with a connection object in a disconnected state;

FIG. 2 is a perspective view showing a connector according to an embodiment of the present invention together with a connection object in a disconnected state;

FIG. 3 is a sectional view of the connector illustrated in FIG. 2;

FIG. 4 is a perspective view of the connector illustrated in FIGS. 2 and 3 when the connection object is connected thereto; and

FIG. 5 is a sectional view of the connector illustrated in FIG. 4 with the connection object connected thereto.

FIG. 6 is a perspective view showing a connector according to another embodiment of the present invention together with a connection object in a disconnected state;

FIG. 7 is a perspective view of the connector illustrated in FIG. 6 when the connection object is connected thereto; and

FIG. 8 is a plan view of the connector illustrated in FIG. 6 when the connection object is connected thereto.

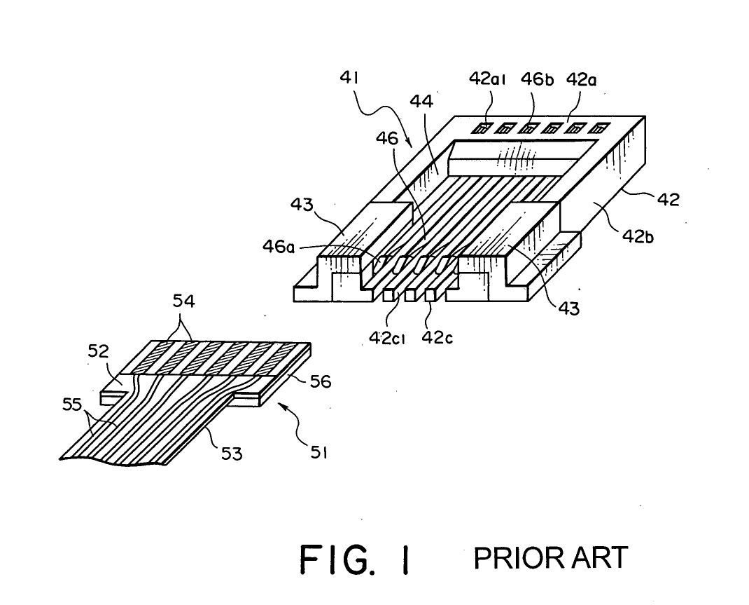

### DESCRIPTION OF THE PREFERRED EMBODIMENTS

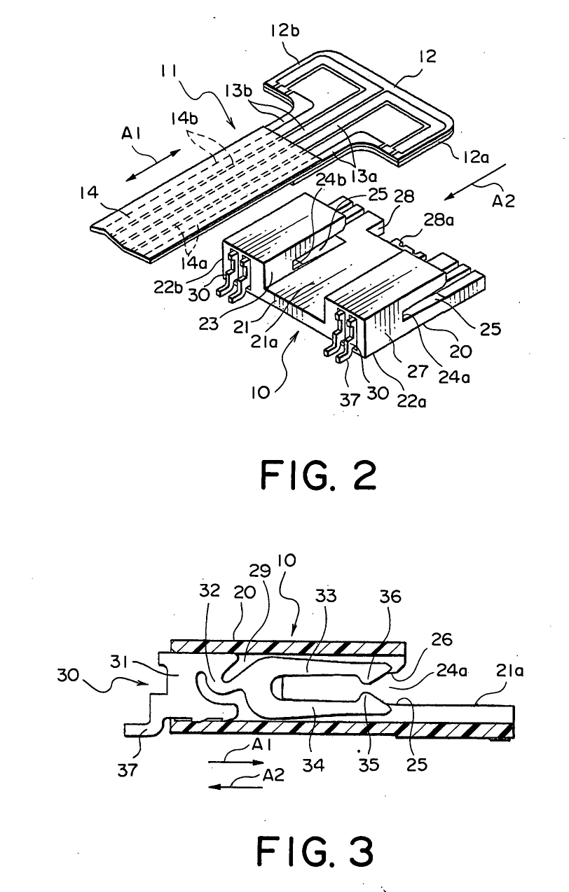

Referring to FIGS. 2 and 3, a connector according to one embodiment of the present invention will be described.

The connector 10 illustrated in FIGS. 2 and 3 serves to connect a flexible board 11 as a connection object. The flexible board 11 comprises a connecting member 12 formed by a generally T-shaped flat-plate, a plurality of wiring patterns 13a and 13b formed on an upper surface of the connecting member 12, a wiring portion 14 connected to the connecting member 12, and a plurality of wiring patterns 14a and 14b formed on a lower surface of the wiring portion 14. The wiring patterns 13 of the connecting member 12 are connected to the wiring patterns 14a and 14b of the wiring portion 14. The connecting member 12 is provided with first and second protruding portions 12a and 12b having a flat shape and formed at opposite sides of an end portion thereof.

In the flexible board 11, a combination of the connecting member 12 and the wiring portion 14 may also be referred to as a wiring portion. In this case, the flexible board 11 is equivalent to a combination of the wiring portion (12, 14) and the first and the second protruding portions 12a and 12b connected to an end portion of the wiring portion in a first direction A1. It is to be noted here that the wiring patterns (13a, 13b, 14a, and 14a) extend from the wiring portion to each of the first and the second protruding portions 12a and 12b.

The connector 10 includes a housing 20 of an insulating plastic material. The housing 20 has a generally rectangular center portion, i.e., a main body portion 21, and first and second side portions 22a and 22b formed at left and right sides of the main body portion 21 to be integral therewith. The housing 20 is provided with a groove or a recess 23 formed between the first and the second side portions 22a and 22b to receive the connecting member 12.

The main body portion 21 has an upper surface, i.e., a receiving surface 21a as a flat surface. The first and the second side portions 22a and 22b are provided with first and second receiving grooves 24a and 24b for receiving the first and the second protruding portions 12a and 12b of the connecting member 12, respectively. The first receiving groove 24a is defined by a reference plane 25 substantially flush with the receiving surface 21a, an opposite plane 26 opposite to the reference plane 25 with a space left therebetween, and a wall portion 27 for locking the movement of the first protruding portion 12a in a second direction A2 opposite to the first direction A1. The second receiving groove 24b has a structure similar to that of the first receiving groove 24a. Thus, the housing 20 has a symmetrical structure. It is to be noted that the reference plane 25 and the opposite plane 26 may be slightly inclined to the receiving surface 21a and to each other.

The main body portion 21 is provided with a recessed portion 28 formed at its end portion in the first direction A1. In the recessed portion 28, a holddown 28a is disposed and attached to the housing 20.

The first side portion 22a has two holding holes 29. In the holding holes 29, a pair of contacts 30 formed by a conductive material are inserted and fixedly held. Similarly, the second side portion 22b has two holding holes 29. In the holding holes 29, another pair of contacts 30 are inserted and fixedly held. Herein, the holding holes 29 of the first side portion 22a will be called first holding holes while the holding holes 29 of the second holding portion 22b will be called second holding holes. The contacts 30 held by the first holding holes will be called first contacts while the contacts 30 held by the second holding holes will be called second contacts.

Referring to FIG. 3, one of the contacts 30 will be described. The remaining contacts 30 have a similar structure.

The contact 30 has a base portion 31 fixed to the housing 20, a curved portion 32 adjacent to one end of the base portion 31, a pair of beam portions 33 and 34 in a bifurcated or branched shape, a pair of contacting portions 35 and 36 formed at end portions of the beam portions 33 and 34, respectively, and a soldering portion 37 formed at the other end of the base portion 31. Each of the curved portion 32 and the beam portions 33 and 34 is elastically deformable. The contacting portion 35 protrudes over the reference plane 25 into the first receiving groove 24a and is therefore called a reference contacting portion. The contacting portion 36 protrudes over the opposite plane 26 into the first receiving groove 24a and is therefore called an opposite contacting portion.

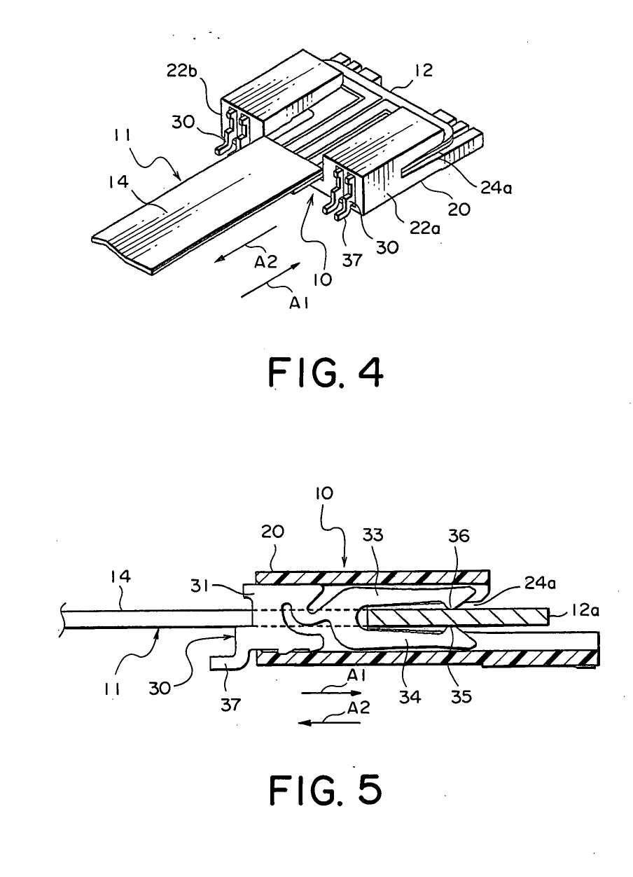

Referring to FIGS. 4 and 5 in addition, an operation of connecting the flexible board 11 to the connector 10 will be described.

At first, the wiring portion 14 of the flexible board 11 is placed on the recessed portion 23 of the housing 20. The first and the second protruding portions 12a and 12 b are faced to the first and the second receiving grooves 24a and 24b, respectively. Next, the flexible board 11 is moved in the second direction A2 to insert the first and the second protruding portions 12a and 12b into the first and the second receiving grooves 24a and 24b, respectively. Then, the contacting portions 35 and 36 of the contacts 30 are elastically press-contacted to opposite surfaces of the first and the second protruding portions 12a and 12b. As a consequence, the wiring patterns 13a and 13b formed on the connecting member 12 are electrically connected to the contacting portions 36 of the contacts 30.

The receiving surface 21a of the main body portion 21 of the housing 20 has a flat shape and, therefore, can be used as a sucked portion to be sucked to a sucking member of an automatic mounting apparatus. Therefore, an operation of mounting the connector 10 to a mounting object by the use of the automatic mounting apparatus is easy.

Since the housing 20 has no such part that interferes the insertion of the flexible board 11, the connector 10 can easily be reduced in size. Even if the flexible board 11 is pulled in the second direction A2, the flexible board 11 is not released from the connector 10 because the protruding portions 12a and 12b are inserted into the receiving grooves 24a and 24b of the housing 20.

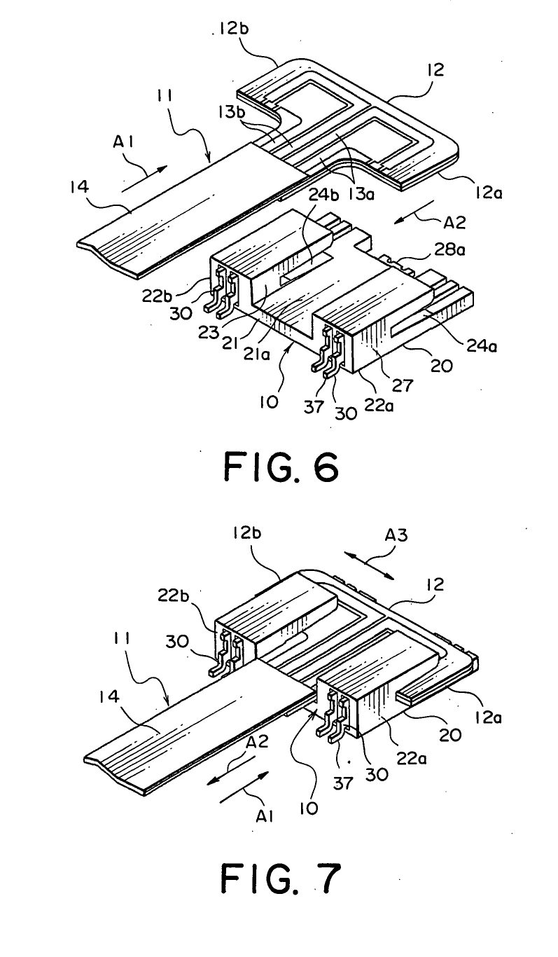

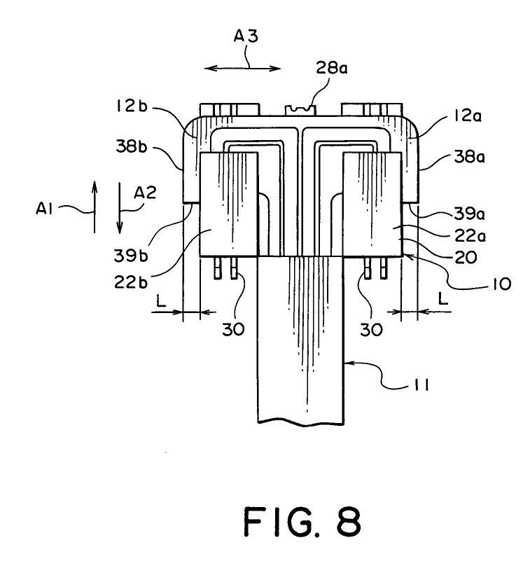

Referring to FIGS. 6 through 8, the description will be directed to a connector according to another embodiment of the present invention. Similar parts or portions are designated by the like reference numerals.

In the connector illustrated in FIGS. 6-8, the protruding portions 12a and 12b have particular portions 38a and 38b exposed outward from the receiving grooves 24a and 24b. Each of the particular portions 38a and 38b protrudes from the housing 20 in a third direction A3 perpendicular to the first and the second directions A1 and A2. In other words, the housing 20 is formed to expose the particular portions 38a and 38b from the first and the second side portions 22a and 22b in the third direction A3.

As a consequence, the particular portions 38a and 38b have engaging portions 39a and 39b, respectively, each of which has a width represented by L. Namely, the housing 20 has a size smaller than that of the connecting member 12 in the third direction A3.

With this structure, it is readily possible to remove the flexible board 11 from the connector 10 by the use of the particular portions 38a and 38b. For example, when the engaging portions 39a and 39b is pushed towards the first direction A1, the flexible board 11 can be moved in the first direction A1 and therefore removed from the connector 10 without causing a buckling of the flexible board 11. In this event, it is unnecessary to form a complicated structure or through holes in the flexible board 11.

While this invention has thus far been described in conjunction with the preferred embodiments thereof, it will be readily possible for those skilled in the art to put this invention into practice in various other manners. For example, the housing may have only one of the side portions. The flexible board may have only one of the protruding portions.

1. A connector for connecting a connection object which has a wiring portion, a first protruding portion protruding from said wiring portion on one side thereof, and a wiring pattern extending from said wiring portion to said first protruding portion, said connector comprising:
a housing; and
a first contact held by said housing,
said housing comprising:
a main body portion provided with a receiving surface for receiving said wiring portion; and
a first side portion disposed at one side of said main body portion, said first side portion having a first receiving groove for receiving said first protruding portion, said first contact being held by said first side portion so as to be connected to said wiring pattern of the first protruding portion.

2. The connector according to claim 1, wherein said first protruding portion has a particular portion exposed outside of said first receiving groove.

3. The connector according to claim 1, wherein said connection object further has a second protruding portion protruding from said wiring portion on the other side opposite to the one side, said housing further having a second side portion disposed at the other side of said main body portion opposite to the one side, said second side portion having a second receiving groove for receiving said second protruding portion.

4. The connector according to claim 3, further comprising a second contact held by said housing, said connection object having an additional wiring pattern extending from said wiring portion to said second protruding portion, said second contact being held by said second side portion so as to be connected to said wiring pattern of the second protruding portion.

5. The connector according to claim 3, wherein said second protruding portion has a particular portion exposed outside of said second receiving groove.

6. The connector according to claim 1, wherein said first protruding portion is connected to an end portion of said wiring portion in a first direction, said first side portion having a wall portion which defines an end portion of said first receiving groove and which serves to lock movement of said first protruding portion in a second direction opposite to said first direction.

7. The connector according to claim 1, wherein said first protruding portion has a flat shape, said first receiving groove having a reference plane substantially flush with said receiving surface and an opposite plane faced to said reference plane with a space left therebetween.

8. The connector according to claim 7, wherein said first contact has a reference contacting portion protruding over said reference plane into said first receiving groove.

9. The connector according to claim 8, wherein said first contact has an opposite contacting portion protruding over said opposite plane into said first receiving groove.

10. The connector according to claim 9, wherein at least one of said reference contacting portion and said opposite contacting portion is elastically press-contacted with said first protruding portion.

11. The connector according to claim 1, wherein said first side portion has a first holding hole, said first contact being inserted and held in said first holding hole.

12. The connector according to claim 11, wherein said first contact has a soldering portion exposed from said first holding hole.

13. The connector according to claim 1, wherein said housing is formed to expose a part of said first protruding portion from said first side portion.

14. The connector according to claim 1, wherein said receiving surface is a flat surface.
